(19) United States
(12) Patent Application Publication
(10) Pub. No.: US 2005/0088605 A1
(43) Pub. Date: Apr. 28, 2005

(54) Structure of liquid crystal display panel having a plurality of sealing lines

(75) Inventors: In-Jae Chung, Gyeonggi-Do (KR); Ki-Bok Park, Gyeonggi-Do (KR); Su-Woong Lee, Gyeongsangbuk-Do (KR); Sang-Yoon Paik, Seoul (KR)

Correspondence Address: MORGAN LEWIS & BOCKIUS LLP, 1111 PENNSYLVANIA AVENUE NW, WASHINGTON, DC, 20004, US

(73) Assignee: LG. Philips LCD Co., Ltd.

(21) Appl. No.: 10/963,520

(22) Filed: Oct. 14, 2004

(30) Foreign Application Priority Data
Oct. 27, 2003 (KR) 75253/2003
Mar. 30, 2004 (KR) 21850/2004

(51) Int. Cl. G02F 1/1333

(52) U.S. Cl. 349/154

(57) ABSTRACT

A liquid crystal display panel device includes a liquid crystal display panel including first and second substrates, a liquid crystal material between the first and second substrates, a first sealing line at an outer peripheral region of the liquid crystal display panel, and at least one second sealing line spaced from the first sealing line to form a space for receiving an excess of the liquid crystal material.

The present application claims the benefit of Korean Patent Application No. 75253/2003 filed in Korea on Oct. 27, 2003 and Korean Patent Application No. 21850/2004 filed in Korea on Mar. 30, 2004, which are hereby incorporated by reference.

### BACKGROUND OF THE INVENTION

1. Field of the Invention

The present invention relates to a liquid crystal display (LCD) panel, and more particularly, to a structure of an LCD panel that prevents gravity mura and provides a uniform cell gap and durable attachment.

2. Discussion of the Related Art

Recently, various portable electric devices, such as mobile phones, personal digital assistant (PDA) devices, and note book computers, have been actively developed. Thus, flat panel display devices, such as liquid crystal displays (LCDs), plasma display panels (PDPs), field emission displays (FEDs), and vacuum fluorescent displays (VFDs), also have been actively developed. In particular, the LCDs are currently mass produced because of their simple driving scheme and superior image quality.

FIG. 1 is a sectional view showing an LCD panel according to the related art. In FIG. 1, an LCD panel 1 includes an upper substrate 3, a lower substrate 5, and a liquid crystal layer 7 formed between the upper and lower substrates 3 and 5. Although not shown, the lower substrate 5 is an array substrate including a plurality of pixels having a driving device, such as a thin film transistor (TFT), formed in each of the pixels. The upper substrate 3 is a color filter substrate including a color filter layer. In addition, a pixel electrode and a common electrode (not shown) are formed on the lower substrate 5 and the upper substrate 3, respectively. Alignment layers (not shown) are formed on the lower and upper substrates 5 and 3 to align liquid crystal molecules of the liquid crystal layer 7.

In addition, the lower substrate 5 and the upper substrate 3 are attached along a perimeter by a sealing line 9, and the liquid crystal 7 is confined within the perimeter. The liquid crystal molecules of the liquid crystal layer 7 are oriented by the driving device formed on the lower substrate 5, thereby controlling amounts of light transmitted through the liquid crystal layer 7 to display an image.

A fabrication method of an LCD panel includes three sub-processes: a driving device array substrate process for forming the driving device on the lower substrate 5, a color filter substrate process for forming the color filter on the upper substrate 3, and a cell process. The cell process includes attaching the TFT substrate 5 and the color filter substrate 3, forming the liquid crystal layer 7 therebetween, and then processing the attached substrates 5 and 3 as an LCD panel unit. The liquid crystal layer 7 is generally formed by a liquid crystal dipping method or a liquid crystal vacuum injection method.

FIG. 2 is a diagram showing a liquid crystal injection device according to the related art. In FIG. 2, a container 12 having a liquid crystal material 14 contained therein is in a vacuum chamber 10. The vacuum chamber 10 is connected to a vacuum pump (not shown) to maintain a predetermined vacuum/pressure within the vacuum chamber 10. In addition, an LCD panel moving device (not shown) is installed in the vacuum chamber 10 to immerge an injection hole 16 of the LCD panel 1 in the liquid crystal material 14.

When the vacuum/pressure level within the chamber 10 is decreased by an inflow of nitrogen gas (N₂), the liquid crystal material 14 then is injected into the LCD panel 1 through the injection hole 16 due to the pressure difference between the inside and the outside of the LCD panel 1. After the liquid crystal material 14 is completely filled into the LCD panel 1, the injection hole 16 is encapsulated by an encapsulating material.

However, there are several problems with both the liquid crystal dipping injection method and/or vacuum injection method. First, an overall time for injection of the liquid crystal material 14 into the panel 1 is relatively long. In general, a gap thickness between the array substrate and the color filter substrate in the LCD panel 1 is relatively narrow, e.g., a few micrometers. Accordingly, a relatively small amount of liquid crystal material 14 is injected into the LCD panel 1 per unit time. For example, it takes about 8 hours to completely inject the liquid crystal material 14 into a 15-inch LCD panel, and thus, fabricating efficiency is low.

Second, a large amount of the liquid crystal material 14 is needed in the container 12 but only a small portion of the liquid crystal material 14 is actually injected into the LCD panel 1. Thus, a large portion of the liquid crystal material 14 is wasted since any unused portion is exposed to the atmosphere when unloading the LCD panel 1 out of the vacuum chamber 10, thereby increasing fabrication costs.

In order to solve the problems of the related art liquid crystal injection methods such as a liquid crystal dipping method or liquid crystal vacuum injection method, a liquid crystal dispensing method has been introduced. The liquid crystal dispensing method is a method for forming a liquid crystal layer by directly dropping the liquid crystal onto the substrates and dispensing the dropped liquid crystal on the entire panel by attaching the substrates to each other by a pressure.

FIGS. 3 and 4 are conceptual views showing a method for forming a liquid crystal layer by a liquid crystal dispensing method according to the related art. In FIG. 3, a liquid crystal dispensing device 20 is placed above the lower substrate 5 for dispensing a liquid crystal material thereon. Although not shown, the liquid crystal dispensing device 20 includes means for controlling a dropping amount of the liquid crystal material. In addition, the lower substrate 5 may be movable in x and y directions, such that drops of liquid crystal 7 are formed on the lower substrate 5.

Then, as shown in FIG. 4, the lower substrate 5 is attached to the upper substrate 3 by a sealing line 9 formed at a peripheral region of the upper substrate 3. A pressure is applied on the substrates 3 and 5 to facilitate the attachment. This pressure also spreads the liquid crystal 7, thereby forming a liquid crystal layer of a uniform thickness between the upper substrate 3 and the lower substrate 5.

Thus, in the liquid crystal dispensing method, the liquid crystal is directly dropped onto the substrate in a short time period so that the liquid crystal layer in a large LCD may be formed quickly and does not require an encapsulating process for closing an injection hole. Further, unlike the liquid crystal injection method, an outer surface of the panel does not contact the liquid crystal material. Thus, a washing process after the liquid crystal layer formation is not required.

The liquid crystal dispensing method according to the related art has a setback in controlling an amount of the liquid crystal material being dispensed. Generally, the actual amount of the liquid crystal material being dispensed is within a small variation of a preset amount, instead of the exact preset amount. However, an undesired effect occurs when an amount of liquid crystal material being dispensed on the substrate is larger than the preset amount. For example, a liquid crystal layer formed in the LCD panel 1 becomes too voluminous at a high temperature, such that a cell gap of the LCD panel becomes larger than a spacer. Thus, the liquid crystal material flows downwardly because of gravity, thereby generating spot at the lower corner area of the LCD panel by the difference of the gray, which is called a gravity mura, and resulting in a defect. In particular, the cell gap of the LCD panel becomes uneven and provides a poor image. Similar problems occur in the LCD panel having the liquid crystal material formed by the liquid crystal injection method.

### SUMMARY OF THE INVENTION

Accordingly, the present invention is directed to structures of a liquid crystal display panel that substantially obviate one or more of the problems due to limitations and disadvantages of the related art.

An object of the present invention is to provide a structure of an LCD panel that prevents a defect caused by an excessive amount or an expansion of the liquid crystal material.

Another object of the present invention is to provide a structure of an LCD panel that provides reinforced attachment without lowering an aperture ratio of the LCD panel.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, the liquid crystal display panel device includes a liquid crystal display panel including first and second substrates, a liquid crystal material between the first and second substrates, a first sealing line at an outer peripheral region of the liquid crystal display panel, and at least one second sealing line spaced from the first sealing line to form a space for receiving an excess of the liquid crystal material.

In another aspect, the liquid crystal display device includes first and second substrates, a liquid crystal material between the first and second substrates, and at least one receiving room for receiving an excess of the liquid crystal material.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a sectional view showing an LCD panel according to the related art;

FIG. 2 is a diagram showing a liquid crystal injection device according to the related art;

FIGS. 3 and 4 are conceptual views showing a method for forming a liquid crystal layer by a liquid crystal dispensing method according to the related art;

FIG. 5A is a plan view showing a structure of an LCD panel according to an embodiment of the present invention;

FIG. 5B is a sectional view showing the LCD panel shown in FIG. 5A;

FIG. 6 is a view showing a structure of an LCD panel according to another embodiment of the present invention;

FIGS. 7A to 7C are views showing a structure of an LCD panel according to yet another embodiment of the present invention;

FIGS. 8A and 8B are views showing a structure of an LCD panel according to another embodiment of the present invention;

FIGS. 9A and 9B are views showing a structure of an LCD panel according to another embodiment of the present invention; and

FIG. 10 is a view showing one pixel structure formed at an LCD panel according to another embodiment of the present invention.

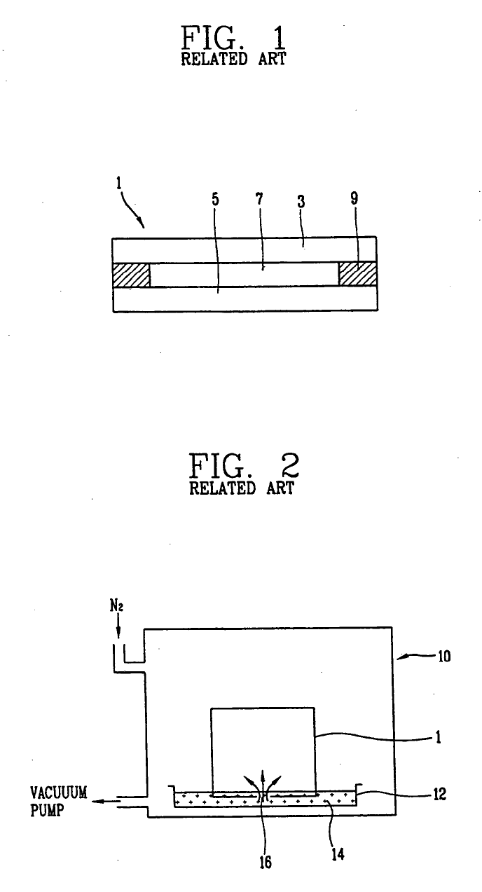

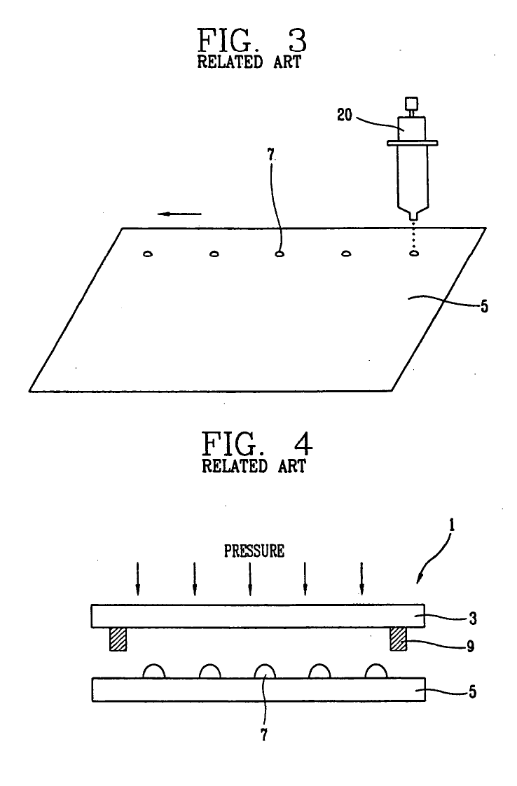

### DETAILED DESCRIPTION OF THE PREFERRED EMBODIMENTS

Reference will now be made in detail to the preferred embodiments, examples of which are illustrated in the accompanying drawings.

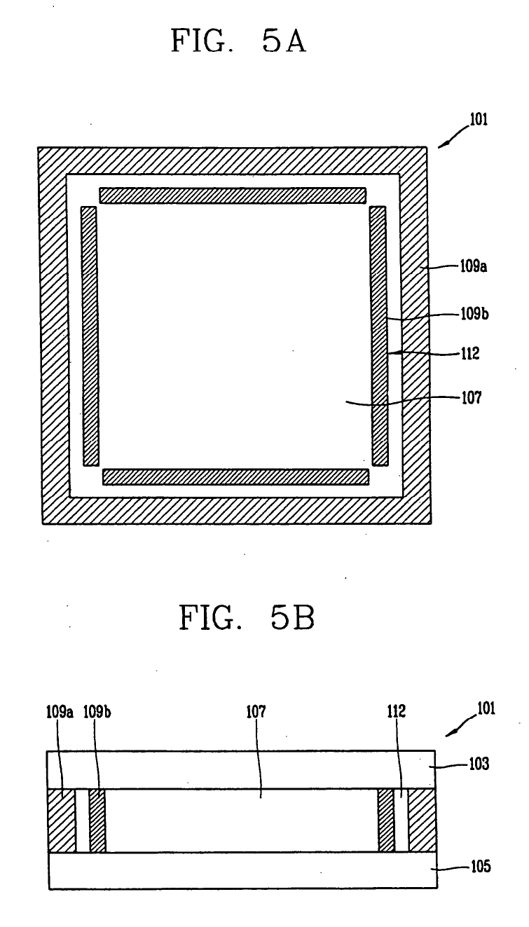

FIG. 5A is a plan view showing a structure of an LCD panel according to an embodiment of the present invention, and FIG. 5B is a sectional view showing the LCD panel shown in FIG. 5A. In FIG. 5A, an LCD panel 101 may have a first sealing line 109a and a second sealing line 109b. The first sealing line 109a may be formed along an entire outer peripheral region of the panel 101, and the second sealing line 109b may be formed discontinuously along four sides of the panel 101. The first and second sealing lines 109a and 109b may have a gap 112 therebetween. In particular, the second sealing line 109b may be formed inside the first sealing line 109a, i.e., at an inner side of an outer peripheral region of the panel 101. In addition, the second sealing line 109b may be formed at a region where an image is not actually displayed, thereby maintaining an aperture ratio of the panel 101.

As shown in FIG. 5B, the panel 101 may have a first substrate 103 and a second substrate 105. The first substrate 103 may be a color filter substrate, and the second substrate 105 may be a TFT array substrate. The first and second substrates 103 and 105 may be attached to each other by the first sealing line 109a. In addition, a liquid crystal layer 107 may be formed between the first and second substrates 103 and 105 and inside the second sealing line 109b.

The first sealing line 109a and the second sealing line 109b may include a thermal hardening resin, an optical hardening resin, or a combination of a thermal hardening resin and an optical hardening resin. Thus, the first and second seal lines 109a and 109b may be hardened by irradiating heat or light thereon as the first and second substrates 103 and 105 are compressed. For example, when the first and second sealing lines 109a and 109b include an ultraviolet hardening resin, an ultraviolet light may be irradiated on the first and second substrates 103 and 105 to harden the first and second sealing lines 109a and 109b.

As a result, the second sealing line 109b not only attaches the first and second substrates 103 and 105 to each other, but also serves as a spacer for maintaining a uniform cell gap of the panel 101. Although not shown, the panel 101 may include other spacers, such as ball spacer or column spacer. Thus, a cell gap may be uniformly maintained without lowering of an aperture ratio of the LCD panel, while an attachment of the LCD panel 101 is reinforced by the second sealing line 109b. Further, the panel 101 has an improved supporting structure, thereby avoiding a gravitational defect caused by containing an excess amount of the liquid crystal material.

In addition, since the second sealing line 109b may be discontinuously formed along the four sides of the panel 101, a passage is formed between the first and second sealing lines 109a and 109b in the gap 112 for flowing an excess amount of the liquid crystal material from an image displaying region to the region where the image is not displayed, thereby providing an additional measure against the gravitational defect in the image display region. In particular, since a volume of liquid crystal is influenced by temperature, which may change greatly during an operation of the panel 101, the volume of the liquid crystal layer 107 varies. Thus, even if the amount of the liquid crystal material being dispensed is not excessive to flow in the passage between the first and second sealing lines 109a and 109b after the fabrication of the panel 101, some of the liquid crystal material may flow into the passage during the operation of the panel 101.

The structure of the LCD panel according to an embodiment of the present invention may be employed for a liquid crystal dispensing method or a liquid crystal vacuum injection method. For example, even when a liquid crystal layer is formed by the vacuum injection method, a volume of the liquid crystal layer inside the LCD panel 101 may still vary during the operation of the panel 101. Thus, the structure having the first and second sealing lines 109a and 109b may prevent a gravitational defect caused by an expended volume of the liquid crystal layer.

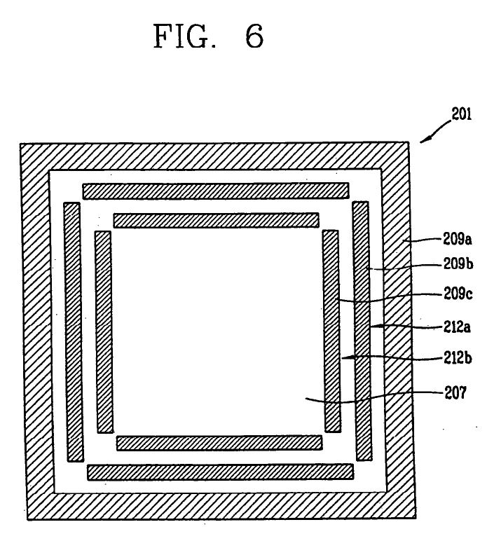

FIG. 6 is a view showing a structure of an LCD panel according to another embodiment of the present invention. In FIG. 6, an LCD panel 201 may have a first sealing line 209a, a second sealing line 209b, and a third sealing line 209c. The first sealing line 209a may be formed along an entire outer peripheral region of the panel 201, and the second and third sealing lines 209b and 209c may be formed discontinuously along four sides of the panel 201. The first and second sealing lines 209a and 209b may have a first gap 212a therebetween, and the second and third sealing lines 209b and 209c may have a second gap 212b therebetween. In particular, the second sealing line 209b may be formed inside the first sealing line 209a, and the third sealing line 209c may be formed inside both the first and second sealing lines 209a and 209b. Thus, an attachment of the LCD panel 201 is reinforced by the second and third sealing lines 209b and 209c, and a cell gap may be uniformly maintained by these additional means.

In addition, the second and third sealing lines 209b and 209c may be formed at a region where an image is not actually displayed, thereby maintaining an aperture ratio of the panel 201. A liquid crystal layer 207 may be formed inside of the third sealing line 209c. As a result, a first passage is formed between the second and third sealing lines 209b and 209c in the second gap 212b and a second passage is formed between the first and second sealing lines 209a and 209b in the first gap 212a for flowing an excess amount of the liquid crystal material from an image displaying region to the region where the image is not displayed. Thus, a further measure against the gravitational defect in the image display region is provided.

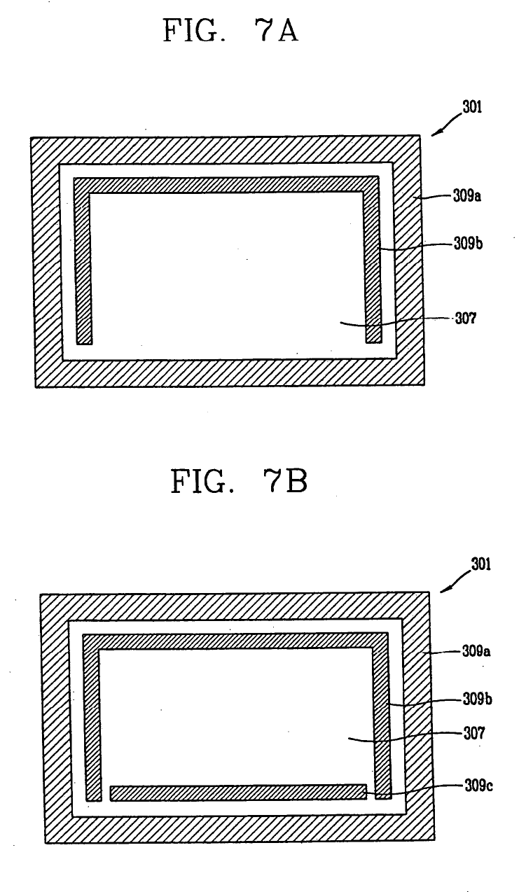

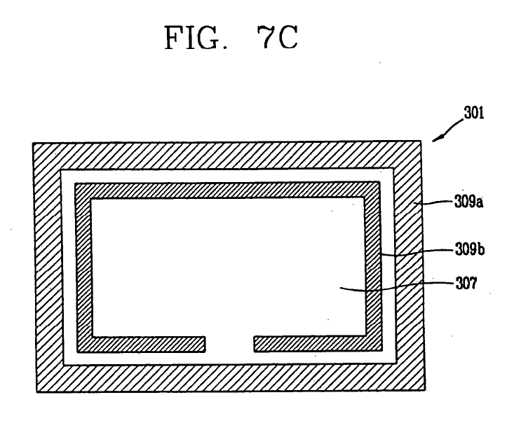

FIGS. 7A to 7C are views showing a structure of an LCD panel according to yet another embodiment of the present invention. In FIG. 7A, an LCD panel 301 may have a first sealing line 309a and a second sealing line 309b. The first sealing line 309a may be formed along an entire outer peripheral region of the panel 301. The second sealing line 309b may have a “U”-like shape and may be formed continuously along three sides of the panel 301 having an opening facing downward. The second sealing line 309b may be formed at a region where an image is not actually displayed. Although not shown, the opening may face any side of the panel 301. As a result, a passage is formed between the first and second sealing lines 309a and 309b. In particular, as gravity pulls an excess amount of the liquid crystal material downward, the excess liquid crystal material may flow into the passage.

As shown in FIG. 7B, a third sealing line 309c also may be formed in the opening of the second sealing line 309b without completely closing the opening. Thus, an excess amount of the liquid crystal material may flow through the gaps between the second and third sealing lines 309b and 309c then into the passage. Alternatively, as shown in FIG. 7C, the second sealing line 309b may be formed along the four sides of the panel 301 and may have an opening along one of its sides. Accordingly, the structure of the LCD panel according to an embodiment of the present invention is not limited to a specific number of the second sealing lines.

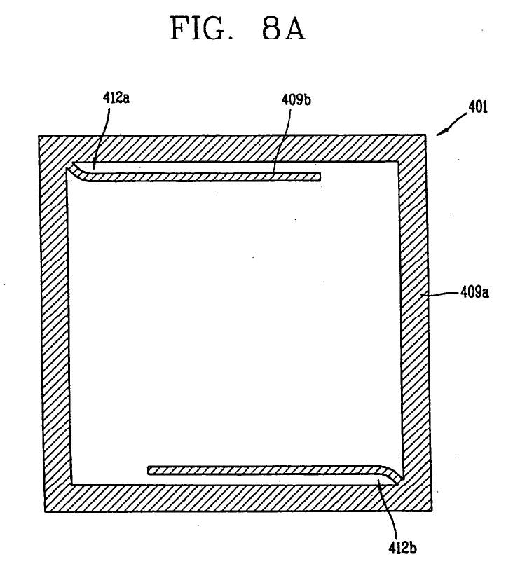

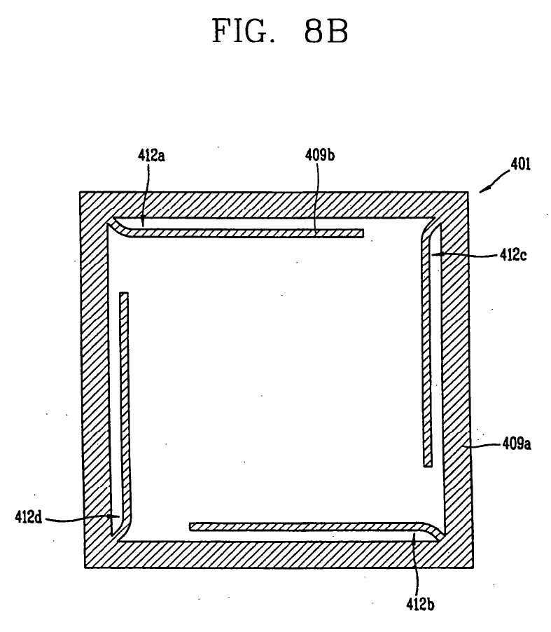

FIGS. 8A and 8B are views showing a structure of an LCD panel according to another embodiment of the present invention. In FIG. 8A, an LCD panel 401 may have a first sealing line 409a and a second sealing line 409b. The first sealing line 409a may be formed along an entire outer peripheral region of the panel 401. In addition, the first and second sealing lines 409a and 409b may be integrally formed. The second sealing line 409b may extend from a corner of the first sealing line 409a and then parallel itself to a side of the first sealing line 409a. The second sealing line 409b may be formed at a region where an image is not actually displayed.

As shown, two passages 412a and 412b may be formed between the first and second sealing lines 409a and 409b for flowing an excess amount of the liquid crystal material from an image displaying region to the region where the image is not displayed. Alternatively, as shown in FIG. 8B, four passages 412a, 412b, 412c, and 412d may be formed between the first and second sealing lines 409a and 409b.

Thus, the structure of an LCD panel according to an embodiment of the present invention may have one or more passages. Further, a length of the second sealing line 409b is not limited to a specific length and sizes of the passages are not limited to the examples shown.

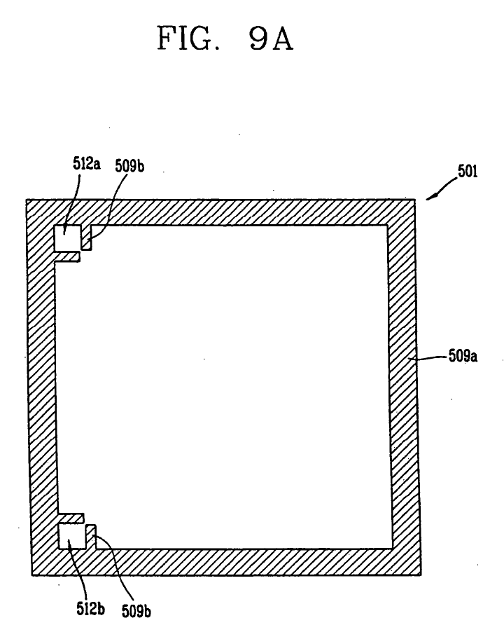

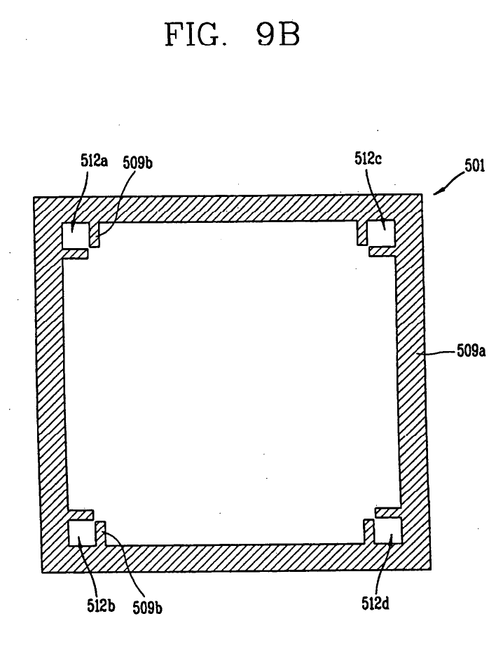

FIGS. 9A and 9B are views showing a structure of an LCD panel according to another embodiment of the present invention. In FIG. 9A, an LCD panel 501 may have a first sealing line 509a and a second sealing line 509b. The first sealing line 509a may be formed along an entire outer peripheral region of the panel 501. In addition, the first and second sealing lines 509a and 509b may be integrally formed. The second sealing line 509b may extend from two neighboring sides of the first sealing line 509a and may form a corner passage 512a or 512b. Alternatively, as shown in FIG. 9B, four passages 512a, 512b, 512c, and 512d may be formed at the four corners of the first sealing line 509a. The second sealing line 509b may be formed at a region where an image is not actually displayed.

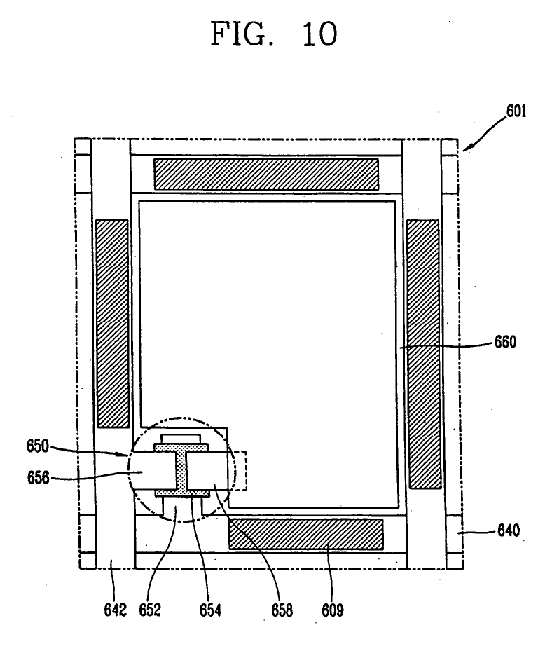

FIG. 10 is a view showing one pixel structure formed at an LCD panel according to another embodiment of the present invention. In FIG. 10, an LCD panel 601 may have a plurality of gate lines 640 formed along a first direction, and a plurality of data lines 642 formed along a second direction intersecting the gate lines, thereby defining a plurality of pixel regions. A pixel electrode 660 and a thin film transistor 650 may be formed in each of the pixel regions. In particular, the thin film transistor 650 may include a gate electrode 652 connected to the gate line 640, a semiconductor layer 654 formed on the gate electrode 652, and a source electrode 656 and a drain electrode 658 formed on the semiconductor layer 654.

In addition, a first sealing line (not shown) may be formed along an entire outer peripheral region of the panel 601, and a second sealing lines 609 may be formed overlapping the gate lines 640 or the data lines 642. Thus, the second sealing lines 609 may be formed in an image displaying region of the panel 601 but in a non-active region, e.g., a black-matrix region, in order to avoid a reduction of an aperture ratio or a picture quality. The second sealing line 609 serves as a spacer and is uniformly formed on the entire LCD panel, thereby more uniformly maintaining a cell gap of the LCD panel.

FIG. 10 shows a structure that the present invention is applied to a twisted nematic mode LCD panel. However, the structure of an LCD panel according to an embodiment of the present invention is not limited to the TN mode LCD panel, but may be applied to LCD panels of various driving modes. For example, the present invention may be applied to an in plane switching (IPS) LCD panel where a pixel electrode and a common electrode are arranged substantially in parallel with each other in a pixel thus to form a parallel electric field to a surface of a substrate. In the IPS mode LCD panel, the second sealing line may be formed not only along a gate line or a data line, but also along a pixel electrode or a common electrode arranged in a pixel.

As aforementioned, the structure of an LCD panel according an embodiment of the present invention includes a plurality of sealing lines, to thereby increase an attachment force of the LCD panel and enhance a supporting structure between substrates. Furthermore, a gravitational defect caused by an excess amount of the liquid crystal material or an expansion of the liquid crystal material is prevented. Also, the sealing lines also function used as spacers thus to even more uniformly maintain a cell gap of the LCD panel.

It will be apparent to those skilled in the art that various modifications and variations can be made in the structure of an LCD panel including a plurality of seal lines of the present invention without departing from the sprit or scope of the invention. Thus, it is intended that the present invention covers the modifications and variations of this invention provided they come within the scope of the appended claims and their equivalents.

1. A liquid crystal display panel device, comprising:
a liquid crystal display panel including first and second substrates;
a liquid crystal material between the first and second substrates;
a first sealing line at an outer peripheral region of the liquid crystal display panel; and
at least one second sealing line spaced from the first sealing line to form a space for receiving an excess of the liquid crystal material.

2. The device of claim 1, wherein the liquid crystal material is formed by a liquid crystal dispensing process or a vacuum injection process.

3. The device of claim 1, wherein the second sealing line is formed at a region of the panel where an image is not displayed.

4. The device of claim 3, wherein the second sealing line is formed along at least one side of the liquid crystal display panel.

5. The device of claim 1, wherein the space for receiving the excess of the liquid crystal material is a passage where the excessive liquid crystal material flows.

6. The device of claim 3, wherein the second sealing line is formed along four sides of the liquid crystal display panel.

7. The device of claim 6, wherein the second sealing line has at least one opening.

8. The device of claim 3, wherein the second sealing line is formed along three sides of the liquid crystal display panel.

9. The device of claim 3, wherein the second sealing line is formed at a corner of the liquid crystal display panel.

10. The device of claim 1, wherein the first sealing line and the second sealing line are integrally formed on one of the first substrate and the second substrate.

11. The device of claim 1, wherein the first sealing line and the second sealing line include one of a thermal hardening resin and a photo hardening resin.

12. The device of claim 1, wherein the first sealing line and the second sealing line include a combination of a thermal hardening resin and a photo hardening resin.

13. The device of claim 1, wherein the first substrate includes:
a plurality of gate lines and data lines defining a plurality of pixel regions;
a thin film transistor in each of the pixel regions; and
a pixel electrode in each of the pixel regions.

14. The device of claim 1, wherein the first substrate includes:
a plurality of gate lines and data lines defining a plurality of pixel regions;
a thin film transistor in each of the pixel regions; and
at least one pixel electrode and common electrode in each of the pixel regions.

15. The device of claim 1, further comprising a spacer for uniformly maintaining a cell gap of the liquid crystal display panel.

16. The device of claim 15, wherein the spacer includes a ball spacer.

17. The device of claim 15, wherein the spacer includes a column spacer.

18. The device of claim 17, wherein at least one sealing line of the sealing lines is the column spacer for uniformly maintaining a cell gap of the liquid crystal display panel.

19. A liquid crystal display device, comprising:
first and second substrates;
a liquid crystal material between the first and second substrates; and
at least one receiving room for receiving an excess of the liquid crystal material.

20. The device of claim 19, wherein the receiving room is formed by a plurality of seal lines.

21. The device of claim 20, wherein the sealing lines include:
a first sealing line at an outer peripheral region of a liquid crystal display panel; and
at least one second sealing line formed inside of the first sealing line.

22. The device of claim 21, wherein the at least one second seal line is disposed along at least one side of the liquid crystal display panel.

23. The device of claim 21, wherein the at least one second sealing line is disposed at a corner of the liquid crystal display panel.

24. The device of claim 21, wherein the at least one second sealing line functions as a spacer for maintaining a cell gap of the liquid crystal display panel.

25. The device of claim 21, wherein the at least one second sealing line includes an opening for receiving the excess of the liquid crystal material.
